(19) United States
(12) Patent Application Publication
(10) Pub. No.: US 2011/0023280 A1
(43) Pub. Date: Feb. 3, 2011

(54) TORQUE MONITORING ASSEMBLY GUN WITH INTEGRAL VISION SYSTEM

(75) Inventor: David T. Renke, Macomb, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/534,687

(22) Filed: Aug. 3, 2009

(51) Int. Cl. B23Q 17/24; B23Q 17/00

(52) U.S. Cl. 29/407.02; 29/720; 29/705

(57) ABSTRACT

The present invention is directed to a new and improved method and apparatus for monitoring torque and joint conditions during the manufacturing process, particularly in the automobile industry. For a desired assembly of automobile members and fasteners is encountered during manufacturing, the optimal torque data and optimal joint data are retrieved from the data storage device. The tension sensor and the rotation sensor monitor the torque condition and joint condition and direct a controller to send torque instruction until the optimal torque condition and optimal joint condition are achieved.

### FIELD OF THE INVENTION

The present invention relates to inspection of manufactured assemblies, more specifically to the inspection of torque specifications and joint specifications in manufactured automobile assemblies.

### BACKGROUND OF THE INVENTION

There is a need for additional error-checking in the automobile assembly process. The automobile assembly process requires joining hundreds to thousands of components, in a precise manner, into the final product. Imprecise assembly leads to loss of time, money, and convenience for the manufacturer and the consumer. For the manufacturer, time and expense is lost in repairing the defectively joined components during the warranty period. For the consumer, time and convenience are lost when defectively joined components are repaired under warranty. Moreover, defectively joined components have a shorter than expected life span.

One of the key steps in automobile assembly is joining pluralities of automobile components. For the highest quality product, some types of automobiles components must be joined in a precise manner. Some of the necessary precision involves joining the components at precise torque and joint specifications. For example, if two components are supposed to be rotatably joined, too much torque in fastening the components may lead to poor rotation. Conversely, too little torque may lead to premature separation of the unit containing the joined assembly. Human senses and memory lack the capacity to consistently join components at a precise torque and prior manufacturing processes do not use all means to check for suboptimal torque and joint conditions. Thus it would be desirable to increase quality in the assembly of the automobile components by improving current error-checking means and adding new error-checking means. Furthermore, it would be advantageous to add error-checking means which can be refined over time to produce even more higher quality assembled articles. This invention addresses that issue.

### SUMMARY OF THE INVENTION

The present invention is directed to a new and improved method and apparatus for monitoring torque and joint conditions during the manufacturing process, particularly in the automobile industry. For a given desired assembly of automobile members and fasteners, an optimal torque and optimal joint condition is determined and placed in a data storage device. When the desired assembly of automobile members and fasteners is encountered during manufacturing, the optimal torque data and optimal joint data are retrieved from the data storage device by the processor. The tension sensor and the rotation sensor monitor the torque condition and joint condition and direct a controller to send torque instruction until the optimal torque condition and optimal joint condition are achieved. The sensed torque is determined from the torque fastener as a condition of time, from the torque fastener's visual coordinates over a period of time. The sensed joint condition is determined by the processor's analysis of the current assembly compared with the optimal joint data. If the either the torque condition or the joint condition are not optimum, the controller will communicate instructions to the torque fastener to increase or decrease torque until the optimal torque and optimal joint conditions are present. When the optimal torque condition and joint condition are achieved, the controller signals the operator that the desired assembly is complete.

### BRIEF DESCRIPTION OF THE DRAWINGS

FIG. 1 shows a plan view of an embodiment of the invention at an automobile assembly station.

FIG. 2 shows a logic diagram of an embodiment of the invention.

FIG. 3 shows a top view of a rotation sensor with an automobile member.

FIG. 4 shows a top view of a rotation sensor with an automobile member.

FIG. 5 shows a top view of an alternate rotation sensor with an automobile member.

FIGS. 6A and 6B show a top view of a rotation sensor and fastening device with reference marks at two different timepoints.

FIG. 7 shows a graph of an optimal torque condition.

FIGS. 8A, 8B, and 8C show graphs of suboptimal torque conditions.

FIG. 9 shows a top view of an optimal joint condition.

FIG. 10 shows a top view of a suboptimal/malformed joint condition.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

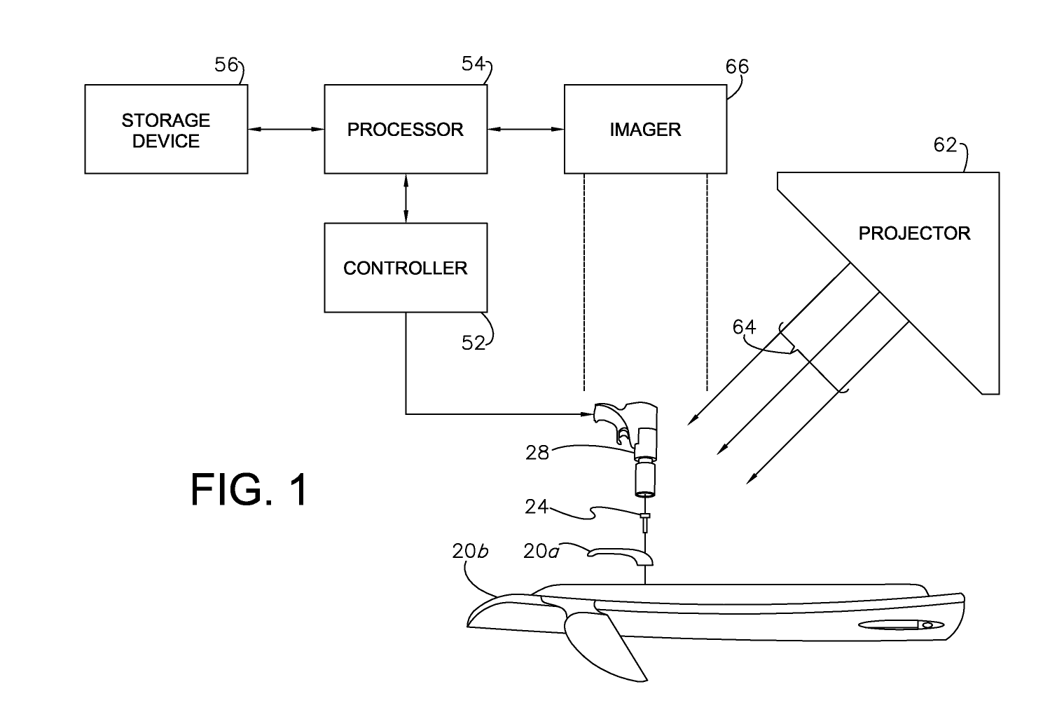

FIG. 1 depicts an embodiment of the invention as it may exist in a manufacturing environment. Disclosed are automobile members 20a, 20b, a fastener 24, fastening device 28, and a rotation sensor 30. The automobile members 20a, 20b can be any plurality of members used to manufacture an automobile. The automobile member 20a, 20b may include any article that is necessary in the manufacture of an automobile. For example, one automobile member may be a door 20a′ and a second automobile member may be a door handle 20b′. Typically, the plurality of automobile members 20a, 20b would constitute a pair. Although automobile members 20a, 20b are illustrated as a door 20a′ and door handle 20b′, one skilled in the art would appreciate that the invention may be used to monitor torque conditions in the assembly of members in other industries.

The fastener 24 preferably is a mechanical fastener 24 which can be any plurality of fasteners 24 used to join the automobile members 20a, 20b. The mechanical fastener 24 may be a bolt, a bolt and nut combination, a screw, a rivet, a pin, or other mechanical fasteners known in the art. The illustrated embodiment depicts a mechanical fastener 24 and an automobile member 20b, the mechanical fastener 22 adapted for rotation by the fastening device 28.

The fastening device 28 can be any device adapted for applying rotational torque to the mechanical fastener 24. Preferably, the fastening device 28 should be able to provide varying levels of instantaneous torque incrementally. Additionally, the fastening device 28 as is generally understood, may be pneumatically or electromagnetically powered. The fastening device 28 is also adapted for electromagnetic communication with the tension sensor 30. While, the preferred embodiment provides for electromagnetic communication, the communication may occur via a physical or nonphysical connection.

A tension sensing device 30, also referred to herein as a tension sensor, is illustrated in FIG. 1 and generally includes a controller 52 in communication with a rotation sensor 60 also referred to herein as an imager. The tension sensor 30 is adapted for communication with the fastening device 28 through the controller 52.

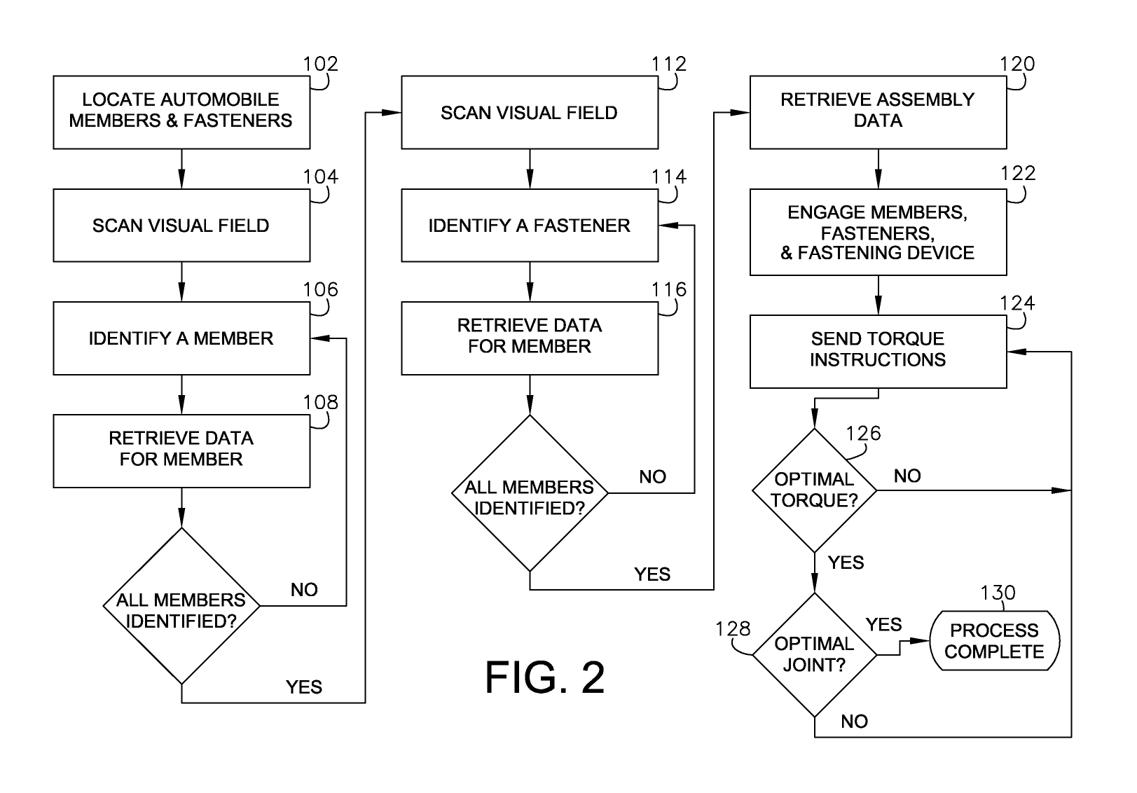

As generally understood, the controller 52 may be any electronic processor 54 based system adapted for executing programmed instructions pursuant to an instruction set such as that illustrated in FIG. 2. Preferably, a general purpose programmable microprocessor would contain the instruction set for the controller 52. Additionally, the controller 52 preferably has an input/output device, an electronic retrievable storage device 56 adapted for storing data, an embedded or programmed instruction set and communications interfaces for operably communicating with various associated devices. For example, the controller 52 should be adapted for a communications interface with the rotation sensor 30, a communications interface with the fastening device 28, and a communications interface with the electronic retrievable data storage device 56. The controller 52 generally operates according to an exemplary instruction set represented by the logic diagram in FIG. 2.

The interface from the controller 52 to both the rotation sensor 30 and the fastening device 28 may be a physical or nonphysical interface. A physical interface would be represented by an electrically or light conductive cable, where the controller 52 would send and receive signals to and from the rotation sensor 30 and the fastening device 28. A nonphysical interface would be represented by electromagnetic or light communication, where the controller 52 would send and receive electrical signals to and from the rotation sensor 30 and the fastening device 28. Through each type of interface, the controller 52 would send and receive information, such as instructions or data, to and from the fastening device 28 and the rotation sensor 30.

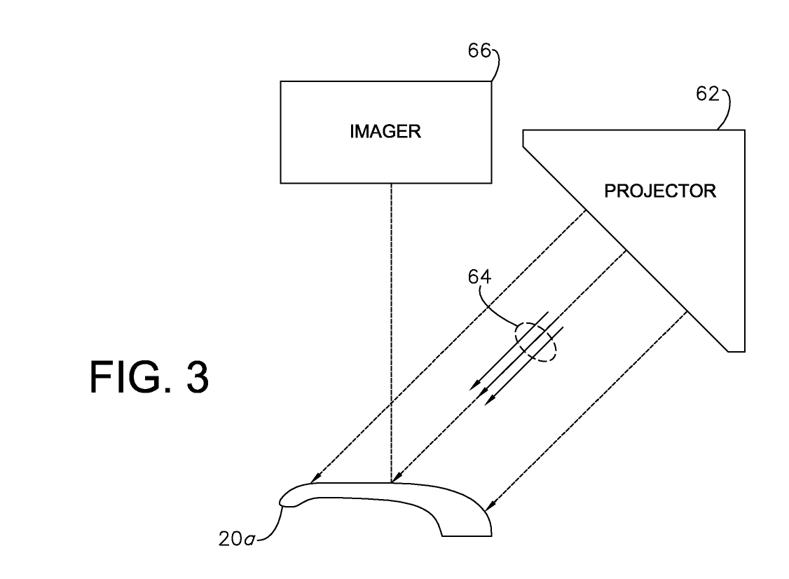

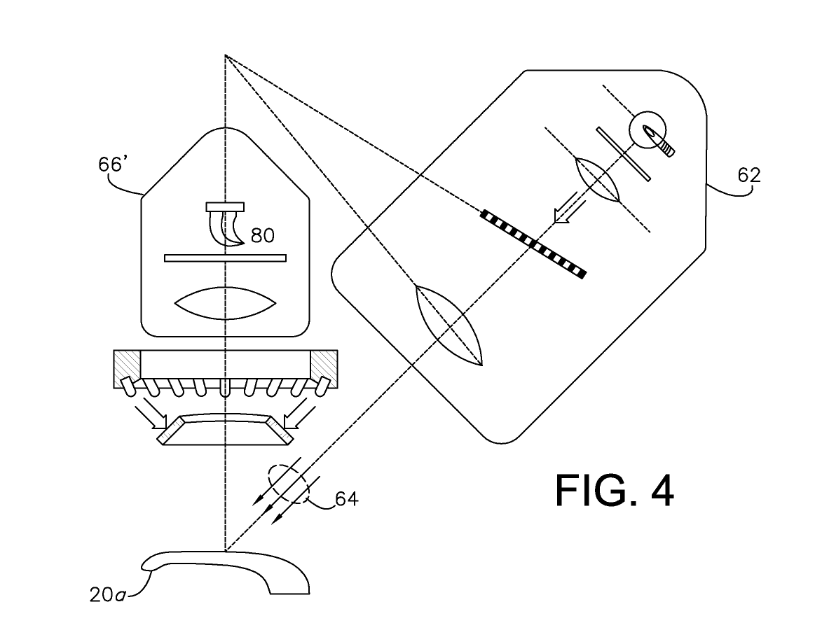

The rotation sensor 30 includes a light source or projector 62 for propagating light 64 across a member 20b and an imager 66 that receives the propagated light 64, as depicted in FIGS. 3, 4, and 5. Discussion of such a device is disclosed in U.S. Pat. No. 6,522,777, which is hereby incorporated by reference.

Referring to FIGS. 1-4, the rotation sensor 30 in communication with the controller 52 via the processor 54 uses two dimensional and three dimensional information to analyze the visual condition of the automobile member 20a. Such analysis may include visual characteristics of the automobile member including the dimensions, color, reflectiveness, depth, and other visual characteristics.

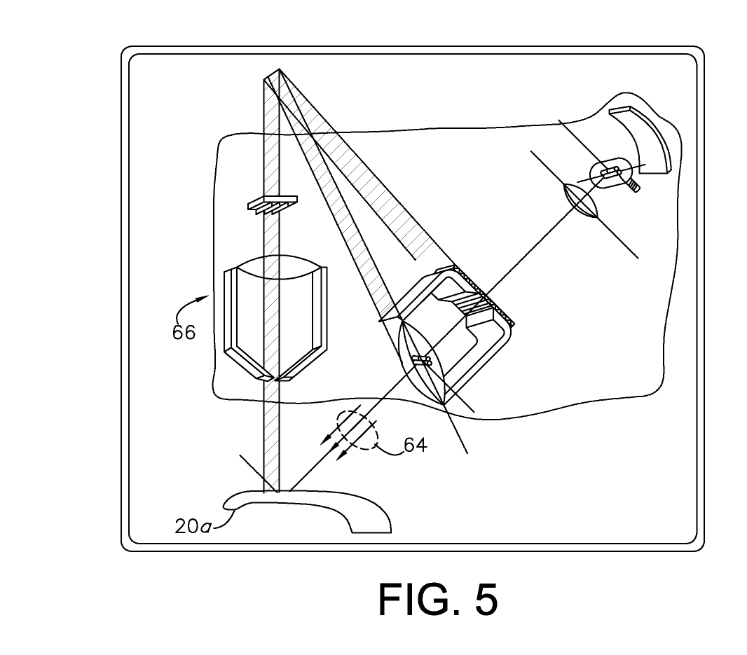

As further illustrated, the rotation sensor 30 includes an imager 66 and projector 62 which are moved relative to the automobile member 20a positioned within a zone of visual range associated with the rotation sensor 30. A projected pattern of light 64, such as a pattern of stripes or lines, is scanned across the surface of the automobile member 20a, which is analyzed based upon the reflected light and which is used to acquire and map out a three dimensional surface associated with the automobile member 20a. The pattern projector 62 projects a pattern of lines and an imager 66 includes a trilinear-array camera 66′ as an imager. The camera 66′ and at least one pattern projector 66′ are maintained in fixed relation to each other. The trilinear-array camera 66′ includes a plurality of linear detector elements 80, each linear detector element 80 having the same fixed number of pixels and each linear detector element 80 extending in a direction parallel with the pattern of light lines 64. The geometry of the imager 66 and projector 62 are arranged such that each linear detector element 80 picks up a different phase in the line pattern projected by the pattern projector 62. As the imager 66 and projector 62 are scanned across the object of interest (namely the automobile member 20a), the linear detector elements 80 communicate the visual data back to the processor 54. Relative depth at each point on the automobile member 20a is determined from the intensity reading obtained from each of the linear detector elements 80 that correspond to the same point on the automobile member 20a. Data on each of these points is communicated and a visual field is formed from the collection of points. Alternatively, this aspect of the rotation sensor can use a different system, such as a Moire interferometry sensor system, to acquire a visual field. A Moire interferometry sensor system is depicted in FIG. 5.

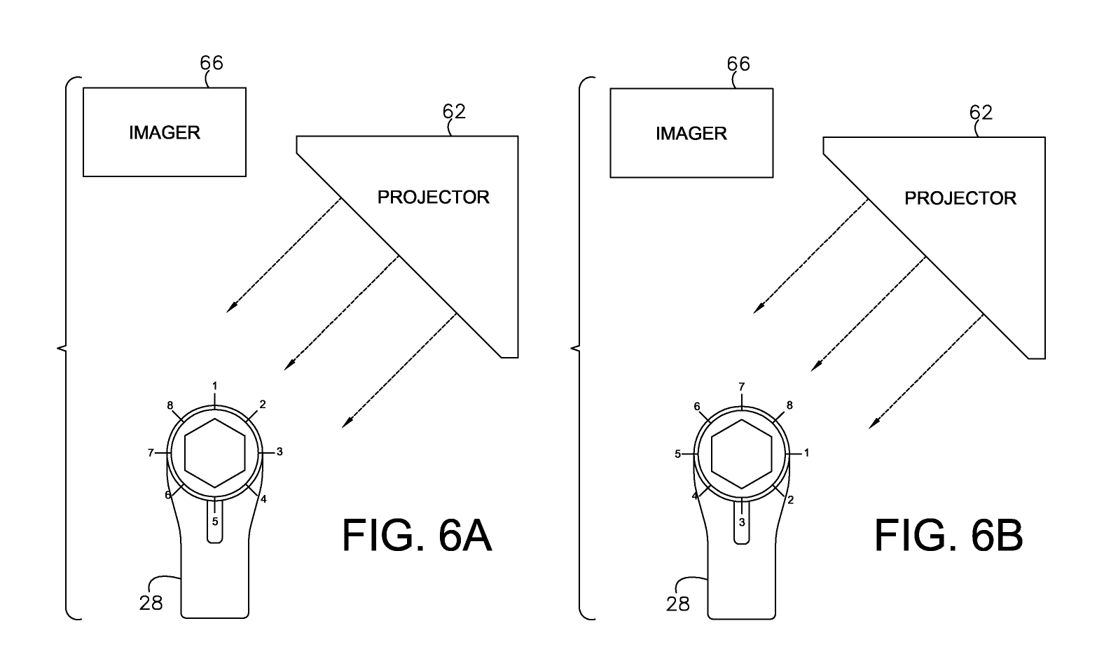

Discussion of tension sensing methods is disclosed in U.S. Pat. No. 4,738,145, which is hereby incorporated by reference. The fastening device 28 may include a mechanical tension sensor 28a, but a tension sensing method used in the current embodiment utilizes the processor 54 to analyze visual feedback from the rotation sensor 30 and the torque provided from the fastening device 28. In this tension sensing method, the rotation sensor 60 is able to monitor the fastening device 28 while it fastens the automobile members 20a, 20b, as is depicted in FIGS. 6A and 6B. The rotation sensor 60 allows for monitoring the rotational distance traveled by the mechanical fastener 24 as a result of torque applied by the fastening device 28. Concurrently, the fastening device 28 provides feedback to the controller 52 regarding the applied torque. With the rotational information and the torque feedback, the processor 54 can monitor the torque over time and thus analyze and predict various torque scenarios.

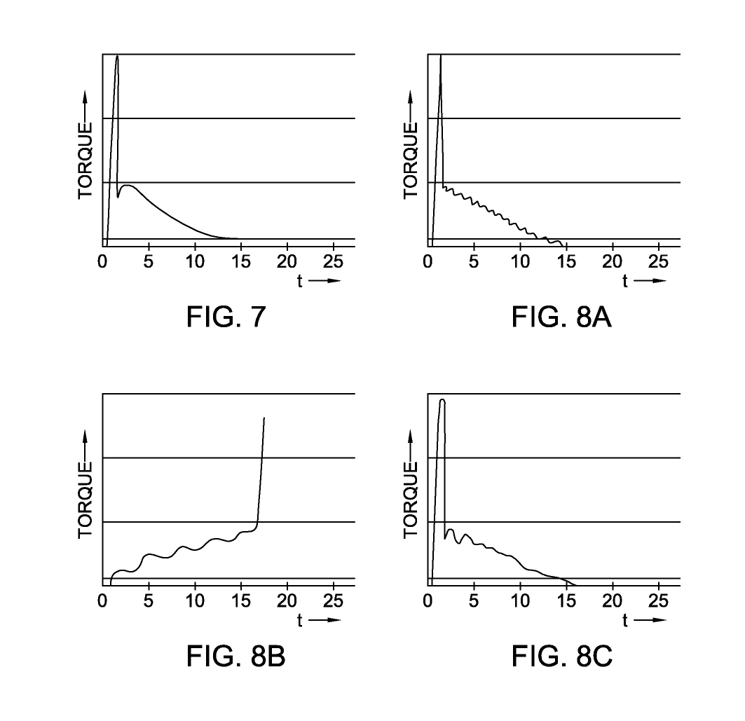

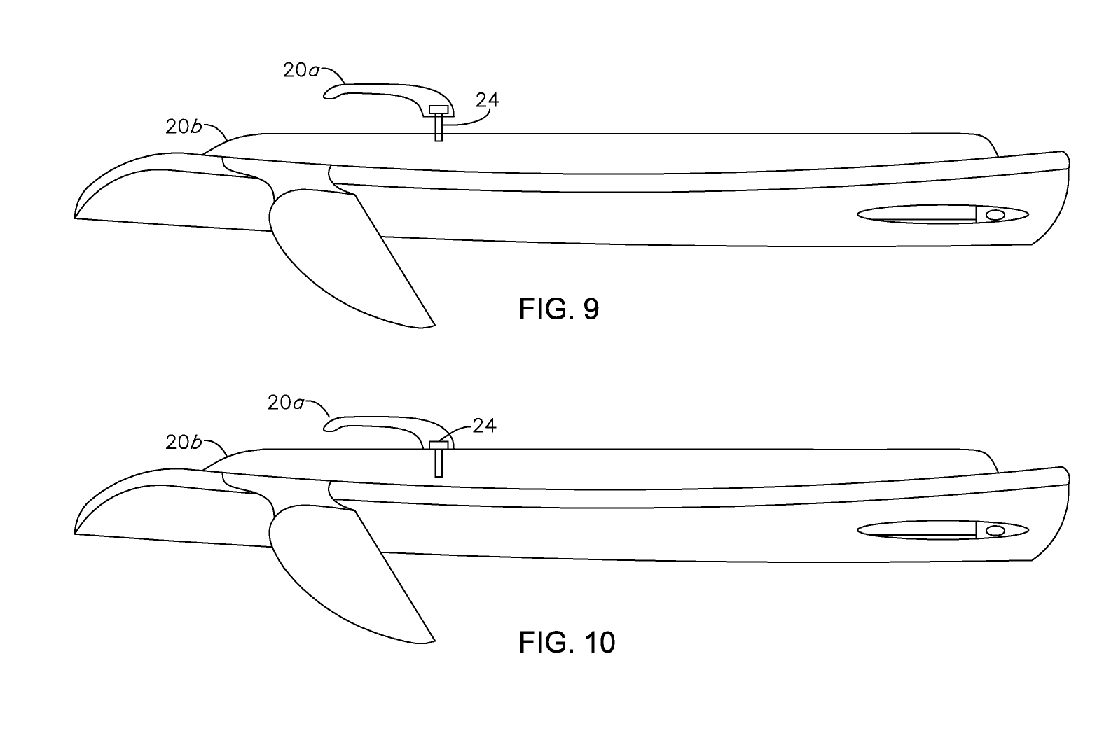

FIG. 7 depicts a sample graph of time versus torque and represents optimal torque data, having no indications of abnormal torque during the fastening period. FIGS. 8A, 8B, and 8C represent suboptimal torque data, having indications of abnormal torque during the fastening period. These indicators of an abnormal torque may include frequently changing slopes or sinusoidally changing torques.

In addition to the tension sensing, the rotation sensor 30 in the present embodiment monitors joined surfaces. After the automobile members 20a, 20b are joined via the fastener 24, a joint is formed at the joined surfaces. Monitoring the status of the joint, in addition to the torque, provides an advantage over single focused techniques. For instance, manufacturing tolerances for typical mechanical fasteners used during the automobile assembly process may present limited understanding of the joined surface and may not detect a suboptimal fastening event. For example, the bolt 24 used to fasten automobile members 20a, 20b may lead to inconsistent manufacturing tolerances which may lead to inconsistent thread density. This different thread density would require a different optimal rotational distance, which in turn would require additional torque for an optimal joint. In this way traditional applications would provide limited advance detection of suboptimal joint which may lead to premature failures in relation to the improved rotation sensor application in the present invention.

The processor 54, in communication with the data storage device 56 and the rotation sensor 30 allows for early detection of suboptimal joints. After the automobile members 20a, 20b are joined by the fastener 24, the rotation sensor 30 records the visual field, including the joint located between the joined surfaces. The rotation sensor 30 then transmits this information to the processor 54 for analysis and retrievable storage by the storage device 56.

The processor 54, in communication with the data storage device 56, analyzes the characteristics of the visual field and matches the characteristics with known characteristics stored within the data storage device to assess the nature of the joined members 20a, 20b and 22 present within the observed visual field. By way of example, the communicated visual field may include certain geometric shapes and other characteristics and visual data. The processor 54 may analyze the recorded visual field and compare those shapes with the shapes in the data retrieved from the data storage device 56. When a match in the shapes occurs, the processor 54, in cooperation with the data storage device 56, can correlate that shape to a particular type of automobile member or a particular type of fastener. The processor 54 iterates through the visual field data until all automobile members and fasteners in the visual field are identified. Although shapes were used as the “key” or “index” to the data, one skilled in the art would appreciate that other visual data, individually or in combination, may be used to identify automobile members 20 and fasteners 22.

Then the processor 54, in communication with the data storage device 56, retrieves the optimal joint data from the data retrievably stored within the data storage device for the given automobile members 20a, 20b and fasteners 24 in the visual field, using the joined surface combination as the key the optimal joint data. As the fastening device 28 provides torque to the fastener 24, the processor 54, in communication with the rotation sensor 30, compares the optimal joint data with the joint data of the assembly in the visual field.

The data storage device 56 contains data on plural automobiles members and plural automobile fasteners. The stored data may be arranged as a database, a table, a series, or either or both in which a row may contain a plurality of automobile members, a plurality of fasteners, optimal torque data for desired assemblies of pluralities of automobile members, pluralities of fasteners, the rotational distance to achieve the optimum torque specification for desired assemblies of automobile members 20 and fasteners 24, and visual indicators of the optimal joint condition.

Portions of the data on the data storage device 56 would be pre-populated prior to distribution and activation within an assembly process. For each automobile member 20 used in the assembly process, a unique identifier and a visual representation of it may be retrievably stored on the storage device 56. For each fastener 24 used in the assembly process, a unique identifier and a visual representation of it would be stored. For each desired assembly of automobile members 20 and fasteners 24 in the manufacturing process, a visual representation or numerical representation corresponding to a visual representation of the joined assembly in optimal torque and optimal joint conditions may be stored for retrieval, analysis, and comparison with observed conditions.

Over time, the data on the data storage device 56 would be updated or increased based upon the recorded observations. Even with quality engineering, optimal joint condition may be refined over time. As given assemblies of automobile members and fasteners are produced and exposed to operational conditions, optimal torque data and optimal joint data may be refined. Over time, the data would be enhanced with subsequent visual representations of torque and joint conditions in combination with warranty or other external data. This additional refinement of optimal torque and optimal joint data leads to less suboptimal assemblies in future manufactured assemblies.

Referring generally to the logic diagram in FIG. 2, the processor 54 may contain instruction related to this invention. In accordance with the illustrated instructions, the storage device 56 would be populated with automobile member and fastener information. Next the automobile members 20a, 20b and the fasteners 22 within the observed visual field would be scanned 104, 112 and then the processor 54 would identify 106, 114 the automobile members 20a, 20b and the fasteners 24. The rotation sensor 30 then records the visual field containing the automobile members 20a, 20b and/or fasteners 24 transmitting the information to the storage device 56 through the processor 54. The processor 54 uses characteristics from the observed visual field such as dimensions, color, emissivity, depth, and other visual characteristics or information to match 108, 116 the observed information with the previously recorded information on the data storage device 56. The processor 54 repeats this step for every item within the visual field until all members and all fasteners have been identified 110, 118.

The processor 54 retrieves 120 the assembly data from the storage device 56 for the corresponding assembled automobile members 20 and fasteners 24. The processor 54 uses the combination of the automobile members 20 and fasteners 22 in the visual field as a key to retrieve the assembly information 120 from the data on the data storage device 54. The retrieved information for a given desired assembly includes the optimal torque data 126 and optimal joint data 128 to be used in fastening the automobile members.

The automobile members, fasteners, and fastening device are then engaged 122. As instructed by the processor 54, the controller 52, sends 124 torque instructions to the fastening device 28. Concurrently, the processor 54 receives visual information from the rotation sensor 30. The processor 54 uses the specified torque provided by the fastening device 28 combined with the rotational distance traveled by fastening device 28, which is determined from the rotation sensor's 30 continuous transmission of the fastening device's 28 position. The processor 54 monitors the torque condition and joint condition and directs the controller 52 to send torque instructions 124 while the torque condition and joint condition are outside the optimal torque specifications and optimal joint specifications retrievably stored within the data storage device 56. Once the processor 54 determines that an optimal torque condition exists 126, the processor 54 then determines if an optimal joint condition exists 128, if not, the controller continues to make adjustments until both an optimal torque condition exists 126 and an optimal joint condition exists 128. In evaluating the joint condition, the rotation sensor 30 records and transmits the visual field, including the joint condition, for evaluation by the processor 54. The processor 54 then compares the data of the newly assembled joint to the optimal joint data retrieved from the data storage device 56. If the conditions are within an acceptable range, the controller 52 signals a successful condition and the fastening device 28 is operably disengaged.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Having thus described the invention, what is claimed as new and desired to be secured by Letters Patent is as follows:

1. A system for forming an assembly from a plurality of automobile members and at least one mechanical fastener, said mechanical fastener having an optimal torque in relation to said assembly and forming an optimal joint in relation to the assembly, said system comprising:
a fastening device in communication with a processor and operated by a controller as directed by the processor;
said processor adapted for retrieving data from a data storage device containing data related to the assembly and selected from the list including characteristic data, torque data and joint data;
a rotation sensor in communication with said processor and adapted for recording visual information related to assembly and transmitting said recorded visual information to said processor; whereby said processor compares said stored data with said transmitted data, and
said controller, through said fastening device, operating said fastening device to provide torque to said mechanical fastener until said visual information corresponds to at least one of said characteristic data, torque data and joint data.

2. The system according to claim 1 further including a tension sensing device.

3. The system according to claim 1 wherein said rotation sensor further includes a projector for propagating light across said assembly.

4. The system according to claim 3 further comprising an image detector that receives the propagated light.

5. The system according to claim 1 wherein said rotation sensor further comprises a zone of visual range.

6. The system according to claim 5 wherein said rotation sensor further comprises an optical head which is moved relative to the assembly positioned within the zone of visual range.

7. The system according to claim 6 wherein said optical head further comprises a pattern projector and an imaging subsystem.

8. The system according to claim 7 wherein said imaging subsystem further includes a trilinear-array camera whereby said camera and said pattern projector are fixed in relation to each other.

9. The system according to claim 8 wherein said trilinear-array camera further comprises a plurality of linear detector elements each extending parallel.

10. The system for forming an assembly from a plurality of automobile members according to claim 1 wherein said mechanical fastener having optimal torque data and optimal joint data in relation to the assembly, said system comprising:
a fastening device adapted for providing rotational force to at least one mechanical fastener, said fastening device associated with a tension sensor;
a controller unit in electronic communication with said fastening device and a processor;
said processor adapted for retrieving data from a data storage device and transmitting said data to said controller;
said data including optimal torque data and optimal joint data and related to the assembly;
a rotation sensor in electronic communication with said processor; and
said controller, through said fastening device, providing torque to said mechanical fastener while in communication with said tension sensor and said rotation sensor.

11. A method for forming an assembly from a plurality of automobile members and at least one mechanical fastener said mechanical fastener having optimal torque data and optimal joint data in relation to the assembly, said method comprising the steps of:
(a) providing a plurality of automobile members, at least one mechanical fastener, a fastening device, a controller, a processor, a data storage device with retrievable data including optimal torque data and optimal joint data related to the assembly, and a rotation sensor in proximity;
(b) said rotation sensor communicating a visual field containing said plurality of automobile members and said mechanical fastener to said processor;
(c) said processor, using said visual field and in communication with said data storage device, identifying said plurality of automobile members and said mechanical fastener;
(d) said processor, using said identified plurality of automobile members and said mechanical fastener, and in communication with said data storage device, retrieving optimal torque data and optimal joint data for said plurality of automobile members and said mechanical fastener in relation to the assembly; and
(e) said controller, in electronic communication with said fastening device and said processor, providing torque to said mechanical fastener, through said fastening device, according to processor communication with said tension sensor and said rotation sensor.
